(19) United States
(12) Patent Application Publication
(10) Pub. No.: US 2026/0079322 A1
(43) Pub. Date: Mar. 19, 2026

(54) HEAD-MOUNTED DISPLAY DEVICE AND ZOOM LENS MODULE

(71) Applicant: HTC Corporation, Taoyuan City (TW)

(72) Inventor: Chih-Hsiang Hsieh, Taoyuan City (TW)

(73) Assignee: HTC Corporation, Taoyuan City (TW)

(21) Appl. No.: 19/086,137

(22) Filed: Mar. 21, 2025

Related U.S. Application Data
(60) Provisional application No. 63/696,379, filed on Sep. 19, 2024.

(51) Int. Cl. G02B 7/10; G02B 15/14; G02B 27/01

(52) U.S. Cl. CPC G02B 7/102; G02B 15/142; G02B 27/0101

(57) ABSTRACT

A head-mounted display device and a zoom lens module are provided. The zoom lens module includes a base, a first lens set, a first cushion, a zoom band, a second lens set, and a second cushion. The first lens set is slidably assembled to the base. The first lens set is adapted to slide relative to the base without rotation along a zoom direction. The first cushion is assembled between the base and the first lens set. The zoom band surrounds an outer peripheral wall of the first lens set and is adapted to slide on the outer peripheral wall. The second lens set is assembled to the base. The first lens set is located between the base and the second lens set. The zoom band is located between the second lens set and the first lens set. The second cushion is assembled between the first lens set and the second lens set. When the zoom band slides on the outer peripheral wall, the zoom band drives the first lens set to slide in the zoom direction.

### CROSS-REFERENCE TO RELATED APPLICATION

This application claims the priority benefit of U.S. provisional application Ser. No. 63/696,379, filed on Sep. 19, 2024. The entirety of the above-mentioned patent application is hereby incorporated by reference herein and made a part of this specification.

### TECHNICAL FIELD

The present application relates to a display device and a lens module, and more particularly to a head-mounted display device and a zoom lens module.

### DESCRIPTION OF RELATED ART

With the rapid advancement of current technology, the types and the functions of head-mounted display devices are becoming increasingly diverse. Taking an eye mask type head-mounted display device as an example, when a user wears such a device, a gyroscope and a position tracker inside the head-mounted display device track the movement of the user to project corresponding scene images, providing the user with an experience as if the user is in a virtual world.

When using the head-mounted display device, since the diopters of myopia of users are different, two zoom lens modules may be provided in the head-mounted display device to suit different users, so that each user can obtain the optimal usage experience. Currently, zooming is performed by rotating a zoom ring to drive a lens assembled in the zoom ring to rotate and move. However, if the zoom ring is slightly deformed during a zoom process, gaps may be generated between parts, allowing dust to enter the zoom lens module, thereby affecting imaging quality.

### SUMMARY

The present application provides a head-mounted display device and a zoom lens module, which can prevent dust intrusion and degradation of imaging quality.

A head-mounted display device of the present application includes a body, a fixing device, and two zoom lens modules. The body has two displays corresponding to both eyes. The fixing device is assembled to the body and is adapted to fix the body to a head of a user. Each of the zoom lens modules includes a base, a first lens set, a first cushion, a zoom band, a second lens set, and a second cushion. The base is assembled to the body and corresponds to one of the two displays. The first lens set is slidably assembled to the base. The first lens set is adapted to slide relative to the base without rotation along a zoom direction. The first cushion is assembled between the base and the first lens set, and is used to surround and seal a space between the base and the first lens set. The zoom band surrounds an outer peripheral wall of the first lens set and is adapted to slide on the outer peripheral wall. The second lens set is assembled to the base. The first lens set is located between the base and the second lens set. The zoom band is located between the second lens set and the first lens set. The second cushion is assembled between the first lens set and the second lens set, and is used to surround and seal a space between the first lens set and the second lens set. When the zoom band slides on the outer peripheral wall, the zoom band drives the first lens set to slide in the zoom direction.

The zoom lens module of the present application includes a base, a first lens set, a first cushion, a zoom band, a second lens set, and a second cushion. The first lens set is slidably assembled to the base. The first lens set is adapted to slide relative to the base without rotation along a zoom direction. The first cushion is assembled between the base and the first lens set, and is used to surround and seal a space between the base and the first lens set. The zoom band surrounds an outer peripheral wall of the first lens set and is adapted to slide on the outer peripheral wall. The second lens set is assembled to the base. The first lens set is located between the base and the second lens set. The second cushion is assembled between the first lens set and the second lens set, and is used to surround and seal a space between the first lens set and the second lens set. When the zoom band slides on the outer peripheral wall, the zoom band drives the first lens set to slide in the zoom direction.

Based on the above, in the head-mounted display device and the zoom lens module of the present application, the cushions may surround and seal the spaces between the parts to prevent dust intrusion, thereby ensuring improved imaging quality.

### BRIEF DESCRIPTION OF THE DRAWINGS

FIG. 1 is a schematic view of a head-mounted display device according to an embodiment of the present invention.

FIG. 2 is a schematic view of a disassembled state of a zoom lens module and a display of the head-mounted display device of FIG. 1.

FIG. 3 is a front view of a first lens frame of the zoom lens module of FIG. 2.

FIG. 4 is a front view of a band body of a zoom band of the zoom lens module of FIG. 2.

FIG. 5 is a schematic view of the zoom lens module of FIG. 2 after being partially assembled.

FIG. 6 is a schematic view of the zoom lens module of FIG. 5 after being partially assembled from another perspective.

FIG. 7 is a partial perspective view of the zoom lens module of FIG. 2 in a state.

FIG. 8 is a cross-sectional view of the zoom lens module of FIG. 7.

FIG. 9 is a partial perspective view of the zoom lens module of FIG. 2 in another state.

FIG. 10 is a cross-sectional view of the zoom lens module of FIG. 9.

### DESCRIPTION OF THE EMBODIMENTS

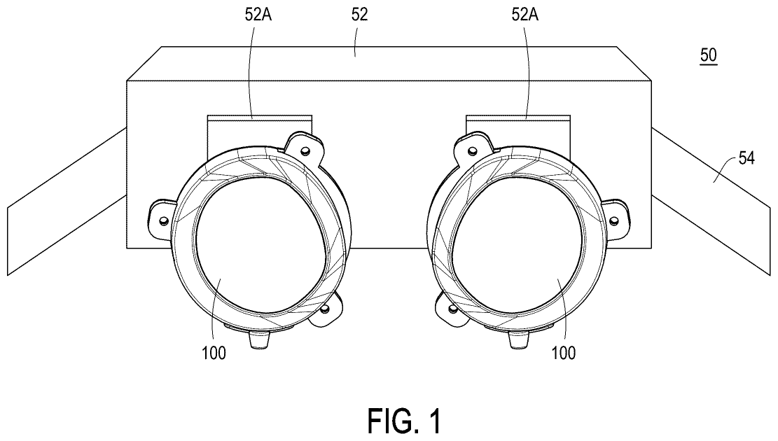

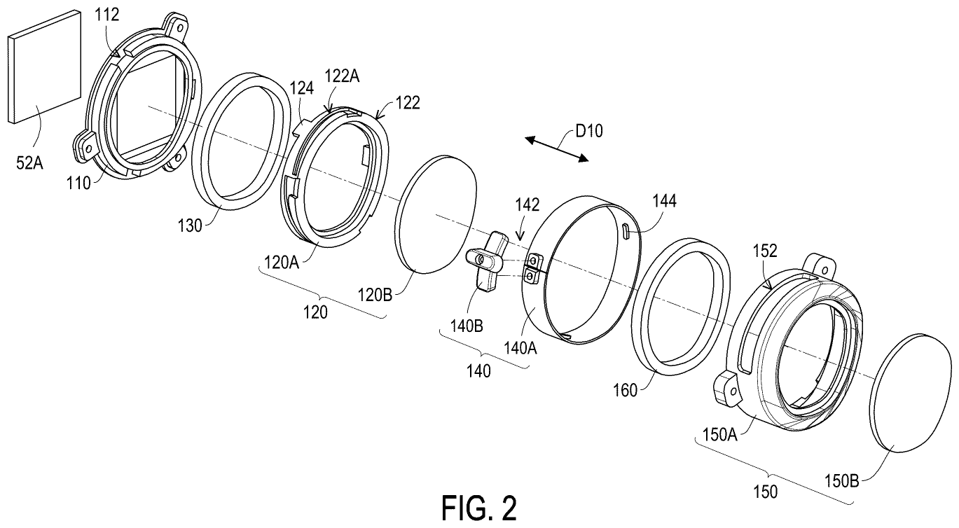

FIG. 1 is a schematic view of a head-mounted display device according to an embodiment of the present invention. FIG. 2 is a schematic view of a disassembled state of a zoom lens module and a display of the head-mounted display device of FIG. 1. Please refer to FIG. 1 and FIG. 2. A head-mounted display device 50 of the embodiment includes a body 52, a fixing device 54, and two zoom lens modules 100. The body 52 has two displays 52A corresponding to both eyes. The fixing device 54 is adapted to fix the body 52 to a head portion of a user. Each zoom lens module 100 includes a base 110, a first lens set 120, a first cushion 130, a zoom band 140, a second lens set 150, and a second cushion 160. Each base 110 is assembled to the body 52 and corresponds to one of the displays 52A.

In the embodiment, the body 52 is a head-mounted display and may be, for example, applied to fields such as a virtual reality system, an augmented reality system, or a mixed reality system. In addition to the zoom lens module 100, the body 52 may also include components such as other optical systems and a protective housing. The fixing device 54 of the embodiment is a temple, but in other embodiments, the fixing device may also be a headband or other fixing devices for fixing the body 52 to the head portion of the user.

The first lens set 120 is slidably assembled to the base 110. The first lens set 120 is adapted to slide relative to the base 110 without rotation along a zoom direction D10. That is, the first lens set 120 does not rotate during the process of sliding and zooming. Therefore, the first lens set 120 may adopt a non-circular lens. The zoom band 140 surrounds an outer peripheral wall 122 of the first lens set 120 and is adapted to slide on the outer peripheral wall 122. The second lens set 150 is assembled to the base 110. That is, there is no relative movement or rotation between the second lens set 150 and the base 110. Roughly viewed along the zoom direction D10, the first lens set 120 is located between the base 110 and the second lens set 150. Roughly viewed along a radial direction, the zoom band 140 is located between the second lens set 150 and the first lens set 120. When the zoom band 140 slides on the outer peripheral wall 122, the zoom band 140 drives the first lens set 120 to slide in the zoom direction D10. That is, as long as a force is applied for the zoom band 140 to rotate around the first lens set 120, the first lens set 120 may slide between the second lens set 150 and the base 110 to achieve the purpose of zooming. In other words, a distance between the first lens set 120 and the second lens set 150 may be adjusted by rotating the zoom band 140 to achieve the purpose of zooming.

In addition, the first cushion 130 is assembled between the base 110 and the first lens set 120 to surround and seal a space between the base 110 and the first lens set 120. The second cushion 160 is assembled between the first lens set 120 and the second lens set 150 to surround and seal a space between the first lens set 120 and the second lens set 150. During the process of the zoom lens module 100 zooming, the first lens set 120 slides between the second lens set 150 and the base 110, that is, the distance between the first lens set 120 and the second lens set 150 changes, and a distance between the first lens set 120 and the base 110 also changes. Since the first cushion 130 and the second cushion 160 adopt buffer materials with elastically changeable volumes, no matter how the distance between the first lens set 120 and the second lens set 150 and the distance between the first lens set 120 and the base 110 change, the first cushion 130 may be kept in a state of being attached to the base 110 and the first lens set 120, and the second cushion 160 may also be kept in a state of being attached to the first lens set 120 and the second lens set 150. In this way, the space between the base 110 and the first lens set 120 and the space between the first lens set 120 and the second lens set 150 may both be sealed to reduce the chance of external dust intrusion, thereby ensuring improved imaging quality. In the embodiment, the first cushion 130 may be fixed to the first lens set 120 or the base 110 by adopting an adhesive or may be fixed to both the first lens set 120 and the base 110 by adopting the adhesive. Similarly, the second cushion 160 may be fixed to the first lens set 120 or the second lens set 150 by adopting the adhesive or may be fixed to both the first lens set 120 and the second lens set 150 by adopting the adhesive.

For example, the first cushion 130 and the second cushion 160 are ring-shaped, contacting an outer region of the first lens set 120 but exposing most of a middle region, so as not to block a travelling path of light. The materials of the first cushion 130 and the second cushion 160 include sponge, foam, or other appropriate buffer materials, such as high-density soft microporous foam made of polyurethane.

The first lens set 120 of the embodiment includes, for example, a first lens frame 120A and a first lens 120B. The first lens frame 120A is slidably assembled to the base 110. The first lens 120B is assembled to the first lens frame 120A. The second lens set 150 of the embodiment includes, for example, a second lens frame 150A and a second lens 150B. The second lens frame 150A is assembled to the base 110. The second lens 150B is assembled to the second lens frame 150A.

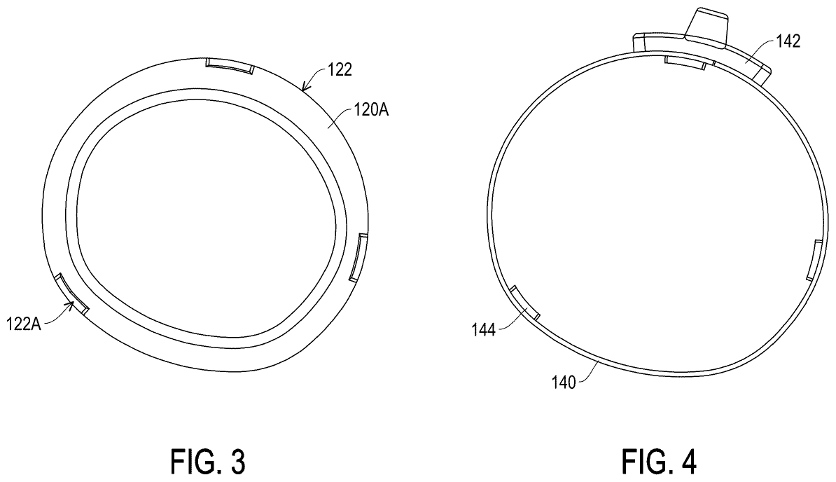

FIG. 3 is a front view of a first lens frame of the zoom lens module of FIG. 2. FIG. 4 is a front view of a band body of a zoom band of the zoom lens module of FIG. 2. Please refer to FIG. 3 and FIG. 4. The outer peripheral wall 122 of the first lens frame 120A of the embodiment has various curvature radii. That is, the outer peripheral wall 122 is not a perfect circle, so as to match the appearance of the first lens 120B. For example, the outer peripheral wall 122 of the embodiment is in an irregular shape, and the curvature radius gradually changes, but the present application is not limited thereto. Since the outer peripheral wall 122 of the first lens frame 120A has various curvature radii, a conventional rigid zoom ring with a perfect circular appearance cannot be used to drive the first lens frame 120A to move. However, the zoom band 140 of the embodiment may be flexible and bendable, so the zoom band 140 may surround the outer peripheral wall 122 and be adapted to snugly slide on the outer peripheral wall 122. Therefore, the zoom band 140 of the embodiment may rotate relative to the first lens frame 120A and is used to drive the first lens frame 120A to move in the zoom direction D10.

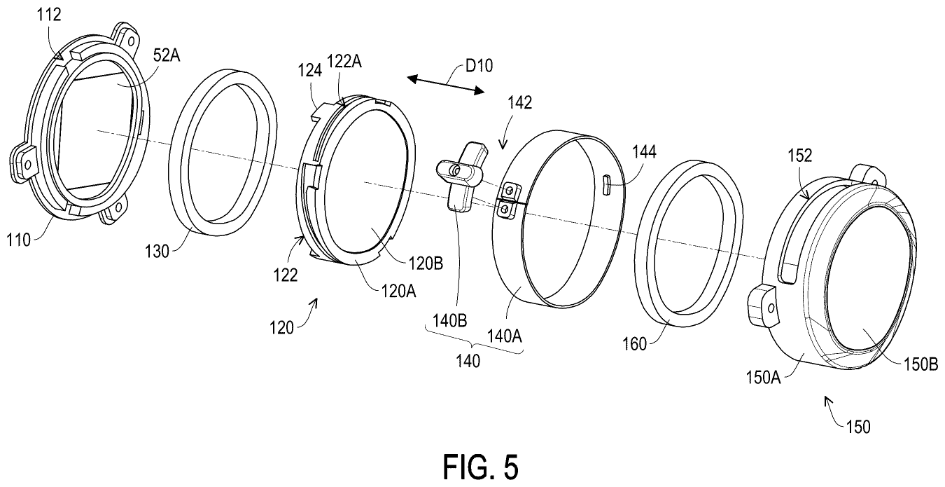

FIG. 5 is a schematic view of the zoom lens module of FIG. 2 after being partially assembled. Please refer to FIG. 2 and FIG. 5. The base 110 of the embodiment has, for example, a space for accommodating the display 52A, so as to fix the relative positions of the base 110 and the display 52A. The first lens 120B is assembled to the first lens frame 120A, so as to fix the relative positions of the first lens 120B and the first lens frame 120A, and the first lens 120B may move along with the first lens frame 120A. The second lens 150B is disposed on the second lens frame 150A, so as to fix the relative positions of the second lens 150B and the second lens frame 150A. The first lens 120B may be composed of one or more lenses, and the second lens 150B may also be composed of one or more lenses.

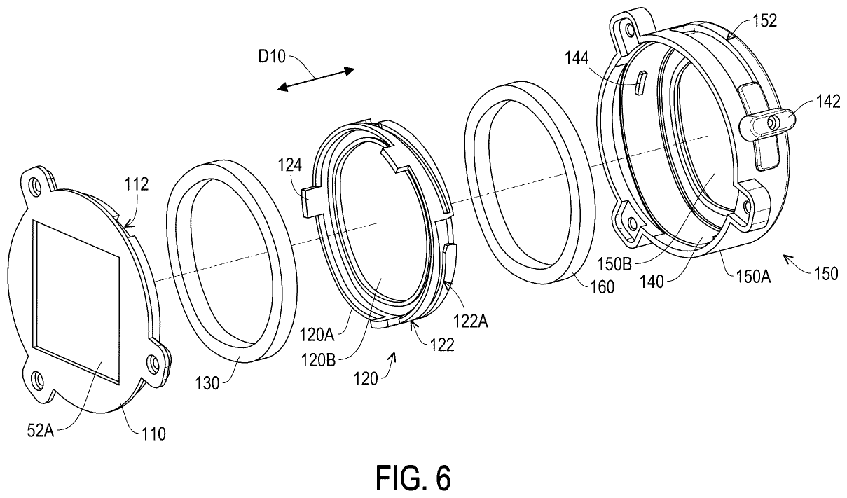

FIG. 6 is a schematic view of the zoom lens module of FIG. 5 after being partially assembled from another perspective. Please refer to FIG. 5 and FIG. 6. The second lens frame 150A has a circumferential slot 152. That is, the circumferential slot 152 is a strip-shaped opening extending along an outer circumferential wall of the second lens frame 150A. The zoom band 140 is suitably disposed on an inner side of the second lens frame 150A. There is a sliding rod 142 on an outer side of the zoom band 140. The sliding rod 142 passes through the circumferential slot 152 and is adapted to slide along the circumferential slot 152. Therefore, through moving the sliding rod 142 exposed from the circumferential slot 152, the zoom band 140 may be driven to rotate relative to the second lens frame 150A.

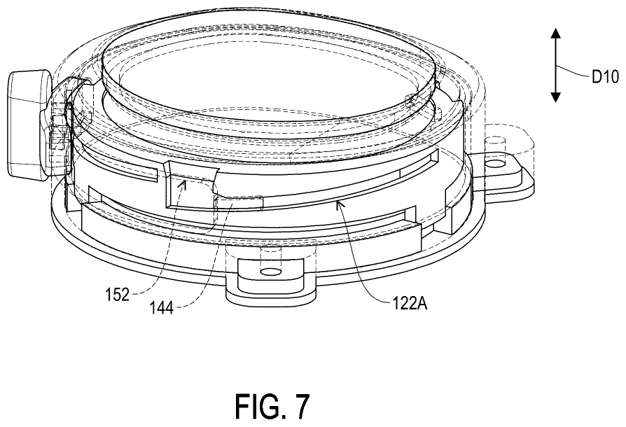

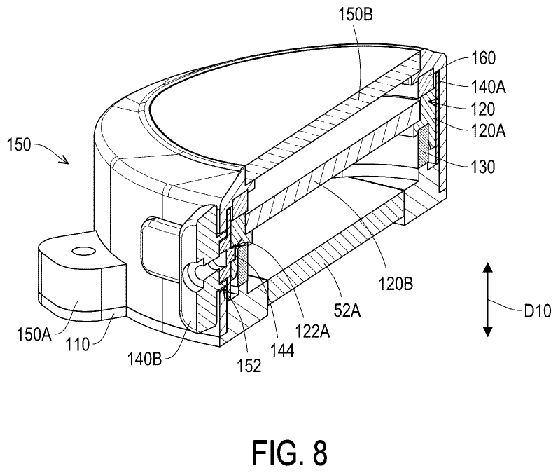

FIG. 7 is a partial perspective view of the zoom lens module of FIG. 2 in a state. FIG. 8 is a cross-sectional view of the zoom lens module of FIG. 7. FIG. 7 shows the first lens 120B, the zoom band 140, the second lens frame 150A, and the second lens 150B in a perspective manner and omits the first cushion 130 and the second cushion 160, so as to clearly see a combination manner of the zoom band 140 and the first lens frame 120A and a combination manner of the base 110 and the first lens frame 120A. Please refer to FIG. 5, FIG. 7, and FIG. 8. The first lens frame 120A is slidably assembled to the base 110. The first lens frame 120A is adapted to slide relative to the base 110 along the zoom direction D10. The outer peripheral wall 122 has an inclined guiding groove 122A. There is a guiding block 144 on an inner side the zoom band 140. The guiding block 144 is embedded in the inclined guiding groove 122A and is adapted to slide along the inclined guiding groove 122A. The second lens frame 150A is assembled to the base 110. That is, the relative positions of and the distance between the second lens 150B on the second lens frame 150A and the display 52A on the base 110 are fixed.

The first lens frame 120A is located between the base 110 and the second lens frame 150A. The zoom band 140 is located between the second lens frame 150A and the first lens frame 120A. Specifically, in the zoom direction D10, the first lens frame 120A is sandwiched between the base 110 and the second lens frame 150A. In the radial direction, the first lens frame 120A surrounds a periphery of a part of the base 110, the zoom band 140 surrounds a periphery of the first lens frame 120A, and the second lens frame 150A surrounds a periphery of the zoom band 140. As can be seen from FIG. 7, in this state, the guiding block 144 on the inner side of the zoom band 140 is located on a lower side of the inclined guiding groove 122A on the left side in FIG. 7. The relative positions of the second lens frame 150A and the base 110 are fixed, and the movement of the zoom band 140 in the zoom direction D10 is also limited by the second lens frame 150A and the base 110. Therefore, when the guiding block 144 of the zoom band 140 is located on the lower side of the inclined guiding groove 122A, the first lens frame 120A is maintained on a higher side in FIG. 7, that is, the first lens 120B is relatively close to the second lens 150B. At this time, the second cushion 160 is compressed to a greater extent, while the first cushion 130 is hardly compressed.

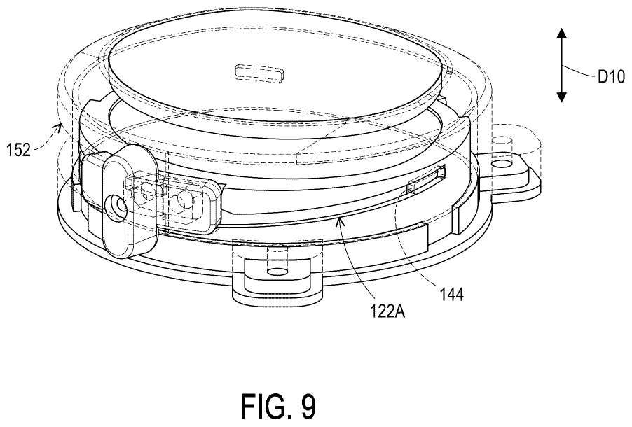

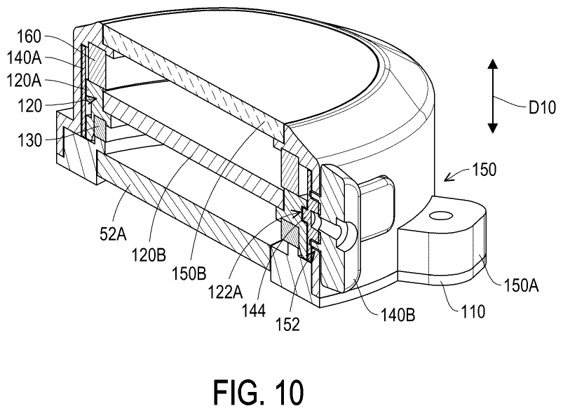

FIG. 9 is a partial perspective view of the zoom lens module of FIG. 2 in another state. FIG. 10 is a cross-sectional view of the zoom lens module of FIG. 9. The first cushion 130 and the second cushion 160 are also omitted in FIG. 9. Please refer to FIG. 5, FIG. 9, and FIG. 10. When the sliding rod 142 is subjected to force and drives the zoom band 140 to slide on the outer peripheral wall 122, the guiding block 144 drives the first lens frame 120A to slide in the zoom direction D10. Specifically, when the sliding rod 142 is subjected to force and drives the zoom band 140 to slide from the position in FIG. 7 to the position in FIG. 9, the guiding block 144 moves from a lower position on the left side of the inclined guiding groove 122A in FIG. 7 to the right side, and the guiding block 144 may, for example, stay on the higher side on the right side of the inclined guiding groove 122A in FIG. 9. During the process of the guiding block 144 of the zoom band 140 moving toward the higher side on the right side of the inclined guiding groove 122A, the guiding block 144 applies force to a wall surface of the inclined guiding groove 122A and pushes the first lens frame 120A. Although the first lens frame 120A cannot rotate, the first lens frame 120A moves toward the bottom of FIG. 9 in the zoom direction D10, that is, the first lens 120B moves in a direction away from the second lens 150B in the zoom direction D10. At this time, the first cushion 130 is compressed to a greater extent, while the second cushion 160 is hardly compressed.

In this way, in the head-mounted display device 50 and the zoom lens module 100 of the embodiment, the relative distance between the first lens 120B and the second lens 150B in the zoom direction D10 may be changed by simply moving the sliding rod 142 to drive the zoom band 140 to rotate, thereby achieving the purpose of zooming. Therefore, not only may the non-circular first lens 120B and second lens 150B be adopted to bring the zoom lens module 100 closer to the eyes of the user, thereby increasing the lens area and the viewing angle, but the zoom function may also be kept. For example, outer contours of the two zoom lens modules 100 in FIG. 1 are relatively flat on the side close to the eyebrow center of the user. For a user with a relatively prominent eyebrow center, such a zoom lens module 100 may be closer to the eyes of the user.

In addition, please refer to FIG. 1 and FIG. 2. In the head-mounted display device 50 of the embodiment, the two zoom lens modules 100 may independently perform zooming. When the user has myopia, the zoom lens module 100 may be zoomed to obtain a clear image. Furthermore, even if the diopters of myopia of both eyes of the user are different, the two zoom lens modules 100 may also be respectively zoomed to different degrees, so that both eyes may obtain clear images.

Please refer to FIG. 5 again. In the embodiment, the number of the guiding blocks 144 is multiple, and the number of the inclined guiding grooves 122A corresponds to the number of the guiding blocks 144. The number of the inclined guiding grooves 122A is slightly more and the inclined guiding grooves 122A are evenly distributed on the entire first lens frame 120A as much as possible, so that the first lens frame 120A may slide more smoothly relative to the base 110. In the embodiment, the material of the zoom band 140 may be nylon, metal, or other flexible materials that are not easily compressed in the length direction to change the length. In the embodiment, the zoom band 140 includes a band body 140A. The band body 140A surrounds the outer peripheral wall 122. Two ends of the band body 140A are adjacent to each other. That is, the zoom band 140 may be formed by wrapping the originally straight band body 140A into a circle. Such a design is easy to manufacture and assemble, and may save costs. In the embodiment, the zoom band 140 may further include a rod body 140B. The rod body 140B is connected to the two ends of the band body 140A and serves as the sliding rod 142. The rod body 140B may not only be used to connect the two ends of the band body 140A, but also may pass through the circumferential slot 152 to serve as the sliding rod 142.

In the embodiment, the first lens frame 120A has multiple sliding blocks 124, and the base 110 has multiple sliding grooves 112 corresponding to the sliding blocks 124. Each sliding block 124 is slidably disposed in the sliding groove 112, so as to be adapted to slide relative to the base 110 along the zoom direction D10.

In summary, in the head-mounted display device and the zoom lens module of the present application, the first cushion is assembled between the base and the first lens set and surrounds and seals the space between the base and the first lens set, and the second cushion is assembled between the first lens set and the second lens set and surrounds and seals the space between the first lens set and the second lens set. Therefore, even if the zoom band is slightly deformed during the zoom process, the cushions may still seal the spaces between the parts, thereby preventing dust intrusion from affecting imaging quality. In addition, when the outer peripheral wall of the first lens frame is irregularly shaped and adapted to fix the irregularly shaped lens, the flexible zoom band is adopted to snugly slide on the outer peripheral wall of the first lens frame, which may increase the lens area and the viewing angle, while also having the zoom function.

What is claimed is:

1. A head-mounted display device, comprising:
a body, having two displays corresponding to both eyes;
a fixing device, assembled to the body and adapted to fix the body to a head of a user;
two zoom lens modules, wherein each of the zoom lens modules comprises:
a base, assembled to the body and corresponding to one of the displays;
a first lens set, slidably assembled to the base, wherein the first lens set is adapted to slide relative to the base without rotation along a zoom direction;
a first cushion, assembled between the base and the first lens set, and used to surround and seal a space between the base and the first lens set;
a zoom band, surrounding an outer peripheral wall of the first lens set and adapted to slide on the outer peripheral wall;
a second lens set, assembled to the base, wherein the first lens set is located between the base and the second lens set, and the zoom band is located between the second lens set and the first lens set; and
a second cushion, assembled between the first lens set and the second lens set, and used to surround and seal a space between the first lens set and the second lens set, wherein when the zoom band slides on the outer peripheral wall, the zoom band drives the first lens set to slide in the zoom direction.

2. The head-mounted display device according to claim 1, wherein the first lens set comprises a first lens frame and a first lens, the first lens frame is slidably assembled to the base, the outer peripheral wall of the first lens frame has a plurality of curvature radii, the outer peripheral wall has an inclined guiding groove, the first lens set is assembled to the first lens frame, the zoom band is adapted to snugly slide on the outer peripheral wall, there is a sliding rod on an outer side of the zoom band, there is a guiding block on an inner side of the zoom band, the guiding block is embedded in the inclined guiding groove and is adapted to slide along the inclined guiding groove, the second lens set comprises a second lens frame and a second lens, the second lens frame is assembled to the base, the first lens frame is located between the base and the second lens frame, the zoom band is located between the second lens frame and the first lens frame, the second lens frame has a circumferential slot, the sliding rod passes through the circumferential slot and is adapted to slide along the circumferential slot, the second lens set is assembled to the second lens frame, and when the sliding rod is subjected to force and drives the zoom band to slide on the outer peripheral wall, the guiding block drives the first lens frame to slide in the zoom direction.

3. The head-mounted display device according to claim 2, wherein a number of the guiding block is plural, and a number of the inclined guiding groove corresponds to the number of the guiding block.

4. The head-mounted display device according to claim 1, wherein materials of the first cushion and the second cushion comprise sponge or foam.

5. The head-mounted display device according to claim 1, wherein a material of the zoom band comprises nylon or metal.

6. The head-mounted display device according to claim 1, wherein the zoom band comprises a band body, the band body surrounds the outer peripheral wall, and two ends of the band body are adjacent to each other.

7. The head-mounted display device according to claim 6, wherein the zoom band further comprises a rod body, and the rod body is connected to the two ends of the band body and serves as the sliding rod.

8. A zoom lens module, comprising:
a base;
a first lens set, slidably assembled to the base, wherein the first lens set is adapted to slide relative to the base without rotation along a zoom direction;
a first cushion, assembled between the base and the first lens set, and used to surround and seal a space between the base and the first lens set;
a zoom band, surrounding an outer peripheral wall of the first lens set and adapted to slide on the outer peripheral wall;
a second lens set, assembled to the base, wherein the first lens set is located between the base and the second lens set, and the zoom band is located between the second lens set and the first lens set; and
a second cushion, assembled between the first lens set and the second lens set, and used to surround and seal a space between the first lens set and the second lens set, wherein when the zoom band slides on the outer peripheral wall, the zoom band drives the first lens set to slide in the zoom direction.

9. The zoom lens module according to claim 8, wherein the first lens set comprises a first lens frame and a first lens, the first lens frame is slidably assembled to the base, the outer peripheral wall of the first lens frame has a plurality of curvature radii, the outer peripheral wall has an inclined guiding groove, the first lens set is assembled to the first lens frame, the zoom band is adapted to snugly slide on the outer peripheral wall, there is a sliding rod on an outer side of the zoom band, there is a guiding block on an inner side of the zoom band, the guiding block is embedded in the inclined guiding groove and is adapted to slide along the inclined guiding groove, the second lens set comprises a second lens frame and a second lens, the second lens frame is assembled to the base, the first lens frame is located between the base and the second lens frame, the zoom band is located between the second lens frame and the first lens frame, the second lens frame has a circumferential slot, the sliding rod passes through the circumferential slot and is adapted to slide along the circumferential slot, the second lens set is assembled to the second lens frame, and when the sliding rod is subjected to force and drives the zoom band to slide on the outer peripheral wall, the guiding block drives the first lens frame to slide in the zoom direction.

10. The zoom lens module according to claim 9, wherein a number of the guiding block is plural, and a number of the inclined guiding groove corresponds to the number of the guiding block.

11. The zoom lens module according to claim 8, wherein materials of the first cushion and the second cushion comprise sponge or foam.

12. The zoom lens module according to claim 8, wherein a material of the zoom band comprises nylon or metal.

13. The zoom lens module according to claim 8, wherein the zoom band comprises a band body, the band body surrounds the outer peripheral wall, and two ends of the band body are adjacent to each other.

14. The zoom lens module according to claim 13, wherein the zoom band further comprises a rod body, and the rod body is connected to the two ends of the band body and serves as the sliding rod.
